(19) United States
(12) Patent Application Publication
(10) Pub. No.: US 2011/0223555 A1
(43) Pub. Date: Sep. 15, 2011

(54) JET DEVICE

(76) Inventor: MICHAEL THOMS, BIETIGHEIM-BISSINGEN (DE)

(21) Appl. No.: 13/081,890

(22) Filed: Apr. 7, 2011

Related U.S. Application Data
(63) Continuation of application No. PCT/EP2009/006622, filed on Sep. 12, 2009.

(30) Foreign Application Priority Data
Oct. 7, 2008 (DE) 10 2008 050 269.3

(51) Int. Cl. A61C 17/022

(52) U.S. Cl. 433/29; 433/88

(57) ABSTRACT

A jet device for use in dentistry has a tool holder providing an abrasive working fluid jet and a spray jet. The working fluid jet contains sharp-edged small abrasive particles suspended in a fast carrier air flow. The spray jet has small water droplets. The working material jet and the spray jet are emitted by spatially separated delivery nozzles. The spray jet thus does not reach to the working jet delivery nozzle.

### CROSS-REFERENCE TO RELATED APPLICATION

This is a continuation application, under 35 U.S.C. §120, of copending international application No. PCT/EP2009/006622, filed Sep. 12, 2009, which designated the United States; this application also claims the priority, under 35 U.S.C. §119, of German patent application No. DE 10 2008 050 269.3, filed Oct. 7, 2008; the prior applications are herewith incorporated by reference in their entirety.

### BACKGROUND OF THE INVENTION

### Field of the Invention

The invention relates to a jet device for use in dentistry.

Jet treatment with abrasive particles is carried out in connection with workpieces.

Impurities on tooth surfaces could also be removed analogously.

### SUMMARY OF THE INVENTION

It is accordingly an object of the invention to provide a jet device which overcome the above-mentioned disadvantages of the prior art devices of this general type.

With the foregoing and other objects in view there is provided, in accordance with the invention a jet device for use in dentistry. The jet device containing a supply unit for storing an abrasive/air mixture, and a handpiece connected to the supply unit and delivering a first jet stream of the abrasive/air mixture.

Such a device can be used in various ways in dental practices for the purpose of removing plaque and tartar from the teeth.

In the device, abrasives can be used that differ in terms of their chemical nature and their hardness. The abrasives, carried in air, form an abrasive working fluid.

According to an added feature of the invention, the supply unit further supplies water in addition to the abrasive/air mixture, and the handpiece, in addition to delivering the first jet stream of the abrasive/air mixture, delivers a second jet stream containing water droplets. The handpiece has first and second delivery nozzles for the first jet stream and the second jet stream. The danger of the delivery nozzle for working fluid becoming blocked is thereby reduced.

In this way, delivery nozzles for the working fluid, which is formed by abrasive entrained in rapidly moving carrier air, can have a passage of very small cross section, in order to permit targeted local treatment of a tooth surface.

It is also desirable for water to be admixed to the working fluid, since in this way the abrasive action can be intensified. To this end, according to the invention, a separate water spray delivery nozzle is provided. A situation in which the fine abrasive forms lumps in the interior of the handpiece when it comes into contact with moisture cannot therefore arise, and therefore the delivery nozzle for working fluid remains free.

In accordance with another feature of the invention, the second jet stream does not cover the first delivery nozzle. This ensures that the spray jet does not directly reach the delivery nozzle for the working jet. This minimizes the danger of liquid being delivered to the abrasive in proximity to the delivery nozzle for the working jet.

In accordance with a further feature of the invention, the second jet stream passes through the first jet stream. This ensures that the working jet and the spray jet pass through each other at a distance from the delivery nozzle for the working jet, which is advantageous in respect of good abrasive properties of the working jet.

Even in the case of a dry working fluid, a situation can arise in which individual particles lump together on account of geometry or as a result of electrical charges. In accordance with an additional feature of the invention, the handpiece has a duct and a vibrator coupled in terms of oscillation to the duct conveying the abrasive/air mixture. This ensures that such material accumulations, as could form in a delivery line in the handpiece, are broken up again by mechanical oscillation.

In accordance with another added feature of the invention, the second delivery nozzle is acted on by water and compressed air and supplies, as the second jet stream, a spray jet. This is advantageous in respect of a particularly fine distribution of the water being delivered to the working jet.

In the treatment of tooth surfaces using jet devices, a visibly dense mist of abrasive particles and water droplets arises in the mouth. This mist adversely affects the view of the treatment site. However, the mist is also undesirable from the health point of view: when it leaves the patient's mouth, it can infect individuals present in the vicinity. In accordance with further added feature of the invention, the handpiece has a vacuum channel and at least one suction opening which is connected to the vacuum channel. With this a large part of the abovementioned mist is sucked off while still in the patient's mouth, specifically in direct proximity to the treatment site, and without an assistant who is otherwise not required per se having to hold and maneuver a separate suction cannula, which action is also disadvantageous in terms of good visibility of the treatment site.

In accordance with another further feature of the invention, the handpiece has a control device for controlling a vacuum acting on the suction openings. Therefore, the intensity of the suctioning of the abovementioned mist composed of abrasive particles and of water droplets can be easily adjusted in terms of intensity.

In accordance with an added feature of the invention, the handpiece has an end section and a majority of the suction openings are distributed across a wall of the end section. This ensures good suctioning of the mist from the treatment site irrespective of the location at which treatment is being carried out and irrespective of whether some of the mist suction openings are covered by soft tissue.

In accordance with yet another feature of the invention, the handpiece has a light exit window and provides good visibility of the treatment site.

In accordance with an additional feature of the invention, the supply unit has a dosing unit and the handpiece has a first adjustment device by which said dosing unit for the abrasive is controlled. Therefore, the quantity of the working fluid delivered in each case to the stream of carrier air can be easily controlled on the handpiece itself.

In accordance with a further feature of the invention, the supply unit has a dosing valve for carrier air and the handpiece has a second adjustment device by which the dosing valve for the carrier air is controlled. Therefore a size of the stream of carrier air can also be easily adjusted on the handpiece.

In accordance with another further feature of the invention, the supply unit has a further dosing valve for water and the handpiece has a third adjustment device by which the further dosing valve for water is controlled and therefore the quantity of water emitted as spray from the handpiece can also be easily adjusted on the handpiece itself.

In accordance with a concomitant feature of the invention, the supply unit has a light source and the handpiece has a fourth adjustment device by which the light source can be controlled. Therefore, the lighting strength at the treatment site can also be quickly and easily adjusted on the handpiece.

Other features which are considered as characteristic for the invention are set forth in the appended claims.

Although the invention is illustrated and described herein as embodied in a jet device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, block diagram of a jet device for treating tooth surfaces with rapidly moving abrasive particles, which device has a supply unit and a handpiece according to the invention;

FIG. 2 is a diagrammatic, side view of a modified handpiece; and

FIG. 3 is a diagrammatic, axial sectional view through the modified handpiece according to FIG. 2.

### DETAILED DESCRIPTION OF THE INVENTION

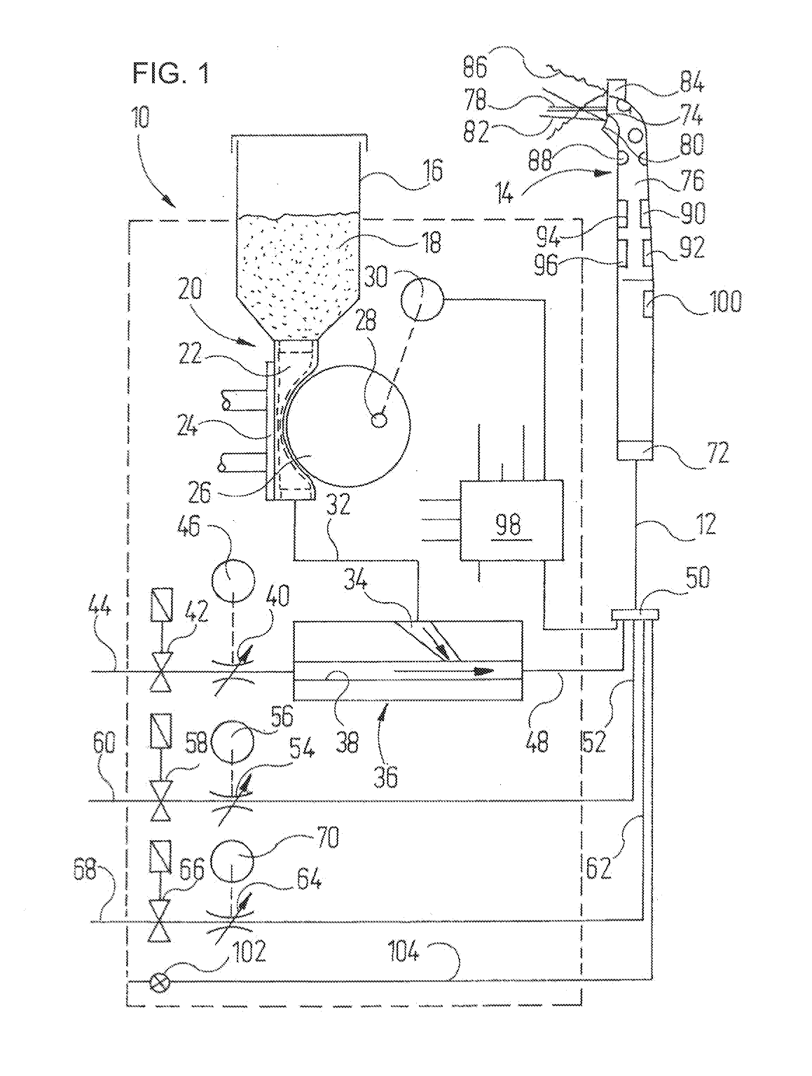

Referring now to the figures of the drawing in detail and first, particularly, to FIG. 1 thereof, there is shown a supply unit 10 of a jet treatment device and is connected to a handpiece 14 via a supply tube 12.

The supply unit 10 contains a storage vessel 16, which holds a supply of abrasive 18. The abrasive is a finely ground, sharp-edged carbonate or phosphate, as is used to treat tooth surfaces. Other abrasives can also be contained in the storage vessel 16.

At the outlet of the storage vessel 16, a dosing valve 20 is arranged which, in the illustrative embodiment being considered here, contains a deformable tube piece 22, which is supported on a support plate 24 when a round press roller 26 is rotated. The press roller 26 sits eccentrically on a shaft 28, which is coupled mechanically to a servomotor 30, as is indicated by a broken line.

In FIG. 1, the dosing valve 20 is shown in the closed state, in which the tube piece 22 is squeezed completely together between press roller 26 and support plate 24.

The outlet of the dosing valve 20 is connected via a duct 32 to an abrasive inlet 34 of an injector 36. The injector 36 has a central channel 38 for carrier air, which channel 38 can be connected to a compressed-air duct 44 via an adjustable throttle 40 and a series-connected solenoid valve 42. The throttle 40 is set by a servomotor 46.

At the outlet of the injector 36, a rapid stream of carrier air is made available in which sharp-edged abrasive particles are suspended. An outlet duct 48 leads to a plug-and-socket connector 50, which is connected to various tubes and ducts of the supply tube 12.

Another duct 52 attached to the plug-and-socket connector 50 provides a vacuum for the handpiece 14. The duct 52 contains a controllable throttle 54, which is adjusted by a servomotor 56. When necessary, a solenoid valve 58 interrupts the connection to a vacuum supply duct 60.

Another duct 62 attached to the plug-and-socket connector 50 can be connected to a fresh-water duct 68 via a controllable throttle 64 and a series-connected solenoid valve 66. A servomotor 70 provides for the adjustment of the controllable throttle 64.

A second end of the supply tube 12 is connected via a plug-and-socket connector 72 to various channels and ducts in the handpiece 14.

One of the ducts leads to a delivery nozzle 74 for a working fluid, which delivery nozzle 74 is arranged at the end of an angled end section 76 of the handpiece 14 in such a way that the axis of the jet is perpendicular to the grip axis of the handpiece 14. The emitted working jet stream 78 composed of rapid carrier air and abrasive has a small opening angle of a few degrees, so as to permit a precise and localized working of the tooth surface.

In addition to the delivery nozzle for working fluid, a spray delivery nozzle 80 is provided, which makes available a spray jet 82 composed of water droplets (and also air if appropriate). The spray jet 82 has a greater opening angle than the working fluid jet, e.g. 15°.

The arrangement of the spray delivery nozzle 80 ensures that the spray jet 82 does not directly reach the delivery nozzle 74 for working fluid but does safely pass through the working fluid jet stream 78, such that liquid and abrasive particles are well mixed.

The end section 76 also supports a light exit housing 84, which makes available a light bundle 86 with a relatively large aperture angle, e.g. 60 to 90°. This light is used to illuminate the treatment site and the area surrounding the latter.

In the wall of the end section 76, there are a number of quite large suction openings 88, which are connected to a vacuum channel of the handpiece 14, which is acted on by vacuum via the supply tube 12. Mist composed of working fluid and water droplets is effectively sucked through the suction openings 88 from the treatment site and delivered to the vacuum system belonging to the dental practice, where the abrasive particles and the liquid are separated.

Moreover, four knurled rollers 90, 92, 94, 96 are mounted on the handpiece 14 and allow the servomotors 30, 46, 56, 70 to be controlled via a control unit 98. A switch 100 on the handpiece 14 serves to switch on and off a light source 102, which is connected to the light exit housing 84 via a light guide 104, the supply tube 12 and a light guide in the handpiece 14.

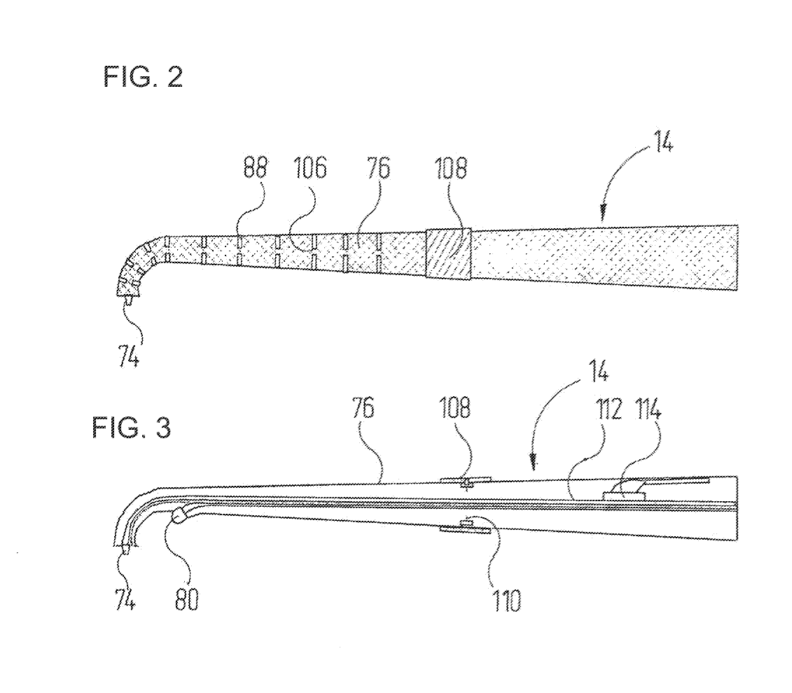

In the illustrative embodiment according to FIGS. 2 and 3, components having the same function as has already been explained with reference to the handpiece according to FIG. 1 are again provided with the same reference numbers. They do not need to be discussed again in detail.

In the handpiece according to FIGS. 2 and 3, the suction openings 88 are narrow rectangular slits, which are each provided in pairs in the top face and bottom face of the end section 76. Only narrow webs 106 remain between them, such that a very effective suctioning of mist from the treatment site is obtained.

In a modification of this, the suction openings 88 in the upper and lower halves of the end section 76 can also be offset relative to one another by half a pitch such that they then have a circumferential extent greater than 180°, in order to further increase the overall suction surface.

On the outside of the handpiece 14, a rotary ring 108 is arranged, which is coupled mechanically to the adjustment pin of an iris diaphragm 110. By rotation of the rotary ring 108, the opening of the iris diaphragm 110 can be changed such without that the vacuum on the suction openings 88 can be acted on in a simple mechanical manner also directly in the handpiece 14.

Instead of an iris diaphragm 110, a circular control disk can also be used which is rotatable about an axis transverse to the axis of the handpiece 14 and is rotatable via a toothed wheel mounted on the control disk shaft, which toothed wheel cooperates with a number collar incorporated in the front or rear face of the rotary ring 108.

In FIG. 3, a duct 112 is made of stainless steel or of another hard material and through which the working fluid is delivered. A vibrator 114, which can be an ultrasonic oscillator, is coupled in terms of vibration to this duct.

By the oscillations transmitted from the vibrator 114 to the duct 112, it is possible to prevent fine abrasive particles from settling and accumulating on the walls of the duct 112.

1. A jet device for use in dentistry, the jet device comprising:
a supply unit for storing an abrasive/air mixture; and
a handpiece connected to said supply unit and delivering a first jet stream of the abrasive/air mixture.

2. The jet device according to claim 1, wherein:
said supply unit further supplies water in addition to the abrasive/air mixture; and
said handpiece, in addition to delivering the first jet stream of the abrasive/air mixture, delivers a second jet stream containing water droplets, said handpiece having first and second delivery nozzles for the first jet stream and the second jet stream.

3. The jet device according to claim 2, wherein the second jet stream does not cover said first delivery nozzle.

4. The jet device according to claims 2, wherein the second jet stream passes through the first jet stream.

5. The jet device according to claim 1, wherein said handpiece has a duct and a vibrator coupled in terms of oscillation to said duct conveying the abrasive/air mixture.

6. The jet device according to claim 2, wherein said second delivery nozzle is acted on by water and compressed air and supplies, as the second jet stream, a spray jet.

7. The jet device according to claim 1, wherein said handpiece has a vacuum channel and at least one suction opening formed therein which is connected to said vacuum channel.

8. The jet device according to claim 7, wherein:
said suction opening is one of a plurality of suction openings formed in said handpiece; and
said handpiece has control means for controlling a vacuum acting on said suction openings.

9. The jet device according to claim 8, wherein said handpiece has an end section and a majority of said suction openings are distributed across a wall of said end section.

10. The jet device according to claim 1, wherein said handpiece has a light exit window.

11. The jet device according to claim 1, wherein:
said supply unit has a dosing unit; and
said handpiece has a first adjustment device by which said dosing unit for the abrasive is controlled.

12. The jet device according to claim 11, wherein:
said supply unit has a dosing valve for carrier air; and
said handpiece has a second adjustment device by which said dosing valve for the carrier air is controlled.

13. The jet device according to claim 12, wherein:
said supply unit has a further dosing valve for water; and
said handpiece has a third adjustment device by which said further dosing valve for water is controlled.

14. The jet device according to claim 13, wherein:
said supply unit has a light source; and
said handpiece has a fourth adjustment device by which said light source can be controlled.
